(19) United States
(12) Patent Application Publication
(10) Pub. No.: US 2005/0056499 A1
(43) Pub. Date: Mar. 17, 2005

(54) Aircraft brake assembly

(75) Inventors: Jean Narcy, Fontenay les Briis (FR); Philippe Chico, Boulogne Billancourt (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI

(21) Appl. No.: 10/914,126

(22) Filed: Aug. 10, 2004

(30) Foreign Application Priority Data
Aug. 28, 2003 (FR) 03 10246

(51) Int. Cl. F16D 55/02; G11B 5/48

(52) U.S. Cl. 188/71.6

(57) ABSTRACT

The invention relates to an aircraft brake assembly comprising a stack of disks surrounding a wheel axle coaxially, said stack being made up of alternating rotor disks constrained in rotation with the wheel, and stator disks constrained in rotation with a torsion tube, and being pressed between a rear retaining piece and the pushers of a plurality of electro-mechanical actuators arranged circumferentially on front support ring. According to the invention, the torsion tube and the ring supporting the electro-mechanical actuators together constitute a one-piece unit which is fastened to the axle, and the rear retaining piece is fastened in separable manner on said one-piece unit at one end thereof.

### FIELD OF THE INVENTION

The present invention relates to the field of braking airplanes, and more particularly to an aircraft brake assembly of the type comprising a stack of disks disposed coaxially around a wheel axle.

### BACKGROUND OF THE INVENTION

Aircraft brake assemblies of conventional type comprise a stack of disks disposed coaxially around a wheel axle, said stack comprising alternating rotor disks constrained to rotate with the wheel, and stator disks constrained in rotation with a torsion tube. The stack of disks is pressed between a rear retaining piece and the pushers of a plurality of actuators disposed circumferentially around a front support ring, in accordance with the introductory portion of claim 1.

In old designs that have been in use for many years, it has been the practice to use hydraulic actuators, where such actuators are fixed to a “hydraulic” ring having the various associated ducts mounted thereon. By way of example, reference can be made to the following documents: U.S. Pat. No. 5,944,147, U.S. Pat. No. 3,887,041, and GB-A-1 302 216. Brake assemblies were then made up of three assemblies, namely: a heat sink constituted by the stack of disks; a torsion tube with an associated rear retaining piece; and a hydraulic ring. Under such circumstances, whenever any repair or maintenance operation needs to be taken on the brake assembly, it has been conventional to remove those three above-mentioned assemblies, in order to be able to disassemble them and perform the required actions.

For several years, aircraft builders have been seeking to replace traditional hydraulic actuators with electro-mechanical actuators. This enables design to be simplified by eliminating the hydraulic ducts which were previously necessary, but it makes it necessary to provide sophisticated control methods in order to conserve absolute safety and reliability. Maintenance is also simplified insofar as fewer maintenance operations need to be performed on the ring and the actuators. Hydraulic actuators are traditionally elements that suffer plastic deformation and require total replacement in order to reinitialize the pushers once they have come to the ends of their strokes after one cycle of disk wear in the stack of disks. By using electro-mechanical actuators, in particular those fitted with respective screw-and-nut type drive systems for their pushers, it is made considerably easier to reinitialize the brake assembly after a disk wear cycle. As a result, the main actions that need to be taken relate essentially to replacing all or some of the disks in the stack of disks.

For technological background relating to replacing carbon disks after a wear cycle, reference can be made to the following documents: U.S. Pat. No. 4,742,895, U.S. Pat. No. 5,494,138, U.S. Pat. No. 5,509,507, U.S. Pat. No. 5,558,186, and U.S. Pat. No. 5,862,890. Reference may also be made to document U.S. Pat. No. 5,992,577 in the name of the Applicant which describes a substitution method that is particularly advantageous.

In most recent systems using electro-mechanical actuators, a torsion tube is provided as used to be the case with hydraulic actuators, which tube is extended rearwards by a retaining piece integral with said tube, the torsion tube being bolted to the ring that supports the actuators (see for example document WO-A-01/20188), or in a variant to a collar on the wheel axle, in which case the ring supporting the actuators is fastened directly to the torsion tube (see for example document EP-A-0 936 373). With this design, when it is desired to remove the set of disks, and after the wheel has been taken off, it is naturally necessary to detach the assembled block constituted by the torsion tube and the rear retaining piece. In practice, the entire functional assembly is taken off, including the ring together with the electro-mechanical actuators which are secured thereto. It is therefore not possible under any circumstances for the disks to be removed in situ, it being necessary for that to be done in a workshop after the entire assembly constituted by the torsion tube and the rear retaining piece has been disassembled. In particular, for the brake assembly described in the above-mentioned document EP-A-0 936 373, the torsion tube is always withdrawn together with the ring supporting the electro-mechanical actuators, with the two parts being disassembled in order to gain access to the stack of disks only in a workshop.

Proposals have also been made for the ring supporting the electro-mechanical actuators to be embodied in the form of a disk forming part of the landing gear. Reference can thus be made to document EP-A-1 048 949 which describes a brake assembly in which the actuator support ring is integral with the wheel axle. In that case also, the torsion tube is integral with the rear retaining piece, and torque is taken up by systems of keys. Such an arrangement is considerably more advantageous than the preceding arrangement, insofar as it enables the assembly constituted by the torsion tube and the stack of disks to be withdrawn separately while leaving the actuators in place mounted on the ring which is constituted by a collar on the axle. Nevertheless, it is not possible to avoid removing the torsion tube if it is desired to detach the stack of disks.

### OBJECT OF THE INVENTION

The present invention seeks to devise an aircraft brake assembly that does not present the above-specified drawbacks, and that makes it possible in particular to remove a stack of disks during a maintenance operation with a minimum amount of disassembly.

Another object of the invention is to provide a brake assembly of a structure that enables its weight to be reduced considerably compared with the above-mentioned prior art embodiments.

### GENERAL DEFINITION OF THE INVENTION

In accordance with the invention, the above-specified problem is solved by an aircraft brake assembly comprising a stack of disks surrounding a wheel axle coaxially, said stack being made up of alternating rotor disks constrained in rotation with the wheel, and stator disks constrained in rotation with a torsion tube, and being pressed between a rear retaining piece and the pushers of a plurality of electro-mechanical actuators arranged circumferentially on front support ring, the torsion tube and the ring supporting the electro-mechanical actuators together constituting a one-piece unit which is fastened to the axle, and the rear retaining piece being fastened in separable manner on said one-piece unit at one end thereof.

Thus, if it is desired to remove the stack of disks, it suffices to disassemble the rear retaining piece, leaving the one-piece assembly constituting the ring and the torsion tube in place on the axle. Such an operation can be performed directly on the tarmac, if it is desired merely to replace the stack of worn disks with a new stack of disks.

Preferably, the one-piece unit forming the ring and the torsion tube presents a single flange (i.e. integral with the one-piece assembly) where the ring and the torsion tube join each other, said flange extending in a plane perpendicular to the axis of said assembly and being fastened to a projecting collar on the axle.

Advantageously, the rear retaining piece is fastened to the one-piece unit, and the one-piece unit is fastened to the axle by bolt means.

In an advantageous embodiment, the ring portion of the one-piece unit has a plurality of lugs projecting radially, each lug supporting an electro-mechanical actuator.

In which case, the lugs of the ring portion of the one-piece unit advantageously extend in a plane that is offset forwards relative to the plane of the fastening flange of said assembly. In particular, each electro-mechanical actuator comprises a housing receiving a screw-and-nut system associated with driving the pusher of said actuator, and an electric motor associated with said housing, said housing passing through the corresponding lug onto which it is fastened directly.

In a particular embodiment, the electric motor of each electro-mechanical actuator extends in a circumferential direction, and said motor is also fastened to the ring portion via an associated appendix thereof disposed between two adjacent lugs.

Finally, the one-piece unit forming the ring and the torsion tube is advantageously made out of a single material.

Other characteristics and advantages of the invention appear more clearly in the light of the following description and the figures of the accompanying drawings, relating to a particular embodiment.

### BRIEF DESCRIPTION OF THE DRAWINGS

Reference is made to the figures of the accompanying drawings, in which:

FIG. 1 is an axial section view showing an aircraft brake assembly in accordance with the invention; and

FIG. 2 is an end view of the above-mentioned assembly, seen from its electromechanical actuator end, the axle collar to which the assembly is fixed not being shown.

### DETAILED DESCRIPTION OF THE INVENTION

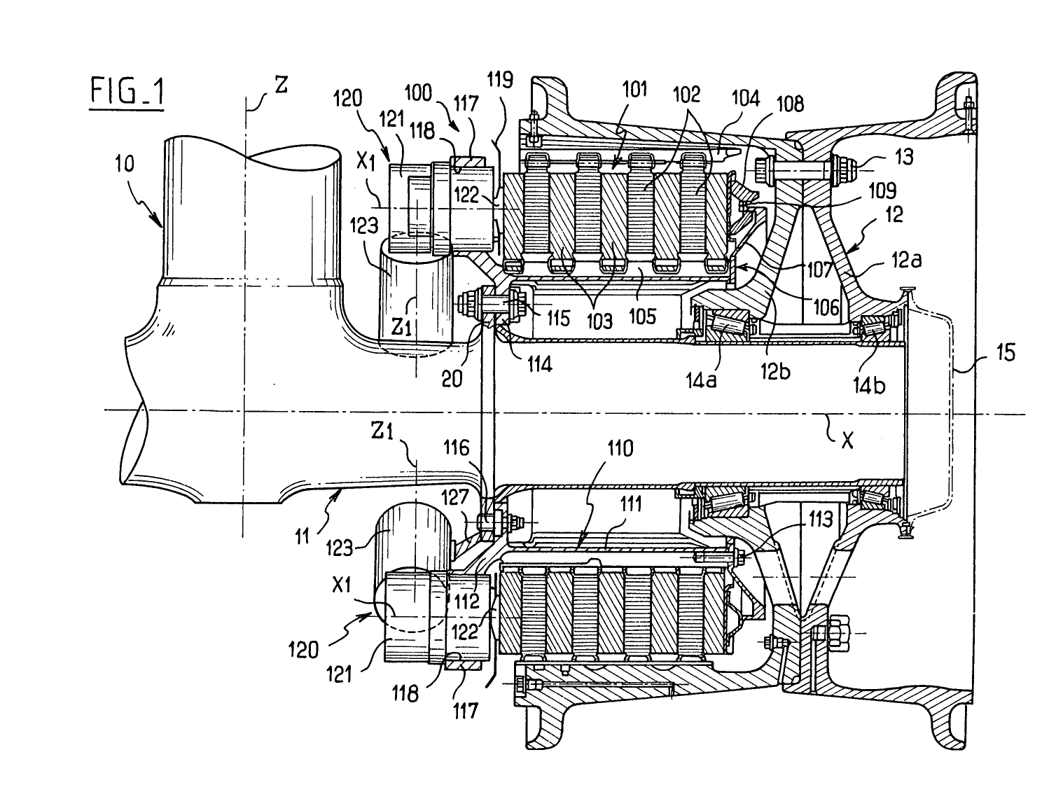

FIG. 1 shows a conventional landing gear structure with an essentially vertical rod 10 of axis Z terminated at its bottom end by two horizontal axles of axis X, only one of which is visible in the figure. The axle 11 carries a wheel 12, in this case implemented in the form of two components 12a, 12b, which are disposed side by side and which are secured to each other by bolt means 13. The wheel 12 rests via roller bearings 14a, 14b on the end of the axle 11. The hollow terminal portion of the axle 11 conventionally houses devices associated with generating a tachometer signal for measuring the speed of the wheel, which devices are not shown herein. All that is shown, in chain-dotted lines, is a closure cap 15 that is fixed on the wheel 12.

In order to brake the wheel 12, a brake assembly referenced 100 is provided. This brake assembly comprises a stack of disks 101 surrounding the wheel axle 11 coaxially.

The stack of disks 101 is made up of alternating rotor disks 102 which are constrained to rotate with the wheel 12 and stator disks 103 which are constrained to rotate with a tubular element 11 referred to as a torsion tube. For this purpose, the wheel 12 is fitted with axial strips 104 which are received in peripheral notches in the rotor disks 102, thereby providing coupling between said disks and the wheel 12. The tubular element forming the torsion tube 11 likewise presents axial strips 105 which are received in peripheral notches of the stator disks 103. The disks 102 and 103 of the stack of disks 101 are made of carbon fiber. The number of disks shown in the drawing is merely by way of example, but in any event the disks forming the two ends of the stack of disks are disks that are secured to the torsion tube, i.e. they are stator disks.

The stack of disks 101 is arranged between a rear retaining piece 106 and a set of electro-mechanical actuators 120 which are disposed circumferentially on a ring acting as a support. In this case, the rear retaining piece 106 is constituted by an annular plate 107 fitted with studs 109 for securing a rear plate 108. In a variant, it is possible to provide retaining systems using spot shoes distributed around the circumference of the rear retaining piece. Each electro-mechanical actuator 102 presents a pusher 122 so that the stack of disks 101 can be pressed between the rear retaining piece 106 and the pushers 122 of the electro-mechanical actuators 120 which are disposed circumferentially on the front support ring referenced 112.

In accordance with an essential aspect of the invention, the torsion tube 111 and the ring 112 supporting the electro-mechanical actuators 120 together constitute a one-piece unit referenced 110 which is secured to the axle 11, and the rear retaining piece 106 is secured in separable manner on said one-piece unit 110, at the end thereof.

The rear retaining piece 106 is secured to the one-piece unit 110 by bolt means 113, arranged in this case level with the axial keying strips 105.

The one-piece unit 110 forming the ring 112 and the torsion tube 111 presents a single flange 114 at the connection between the ring and the torsion tube, said flange lying in a plane perpendicular to the axis X and being secured in separable manner to a projecting collar 20 on the axle 11. Specifically, the one-piece unit 110 is secured to the axle 11 by bolt means 115 passing through associated openings in the collar 20 of the axle 11 and in the single flange 114 of the one-piece unit 110. In addition to the assembly bolts 115, there are also provided centering pegs 116 guaranteeing that the one-piece unit 110 is held accurately in angular position relative to the axle 11.

As can easily be understood, if it is desired to remove the stack of disks 101, it suffices to disassemble the rear retaining piece 106 by taking off the assembly bolts 113 in order to be capable subsequently of gaining access to the stack of disks, and withdrawing it in an axial direction. This operation can thus be performed while leaving the one-piece unit forming the ring and the torsion tube in place. It is then easy to substitute a new stack of disks in situ, after retracting each of the actuators electrically.

The ring portion of the one-piece unit 110 is described below in greater detail, which unit serves to support the electro-mechanical actuators 120.

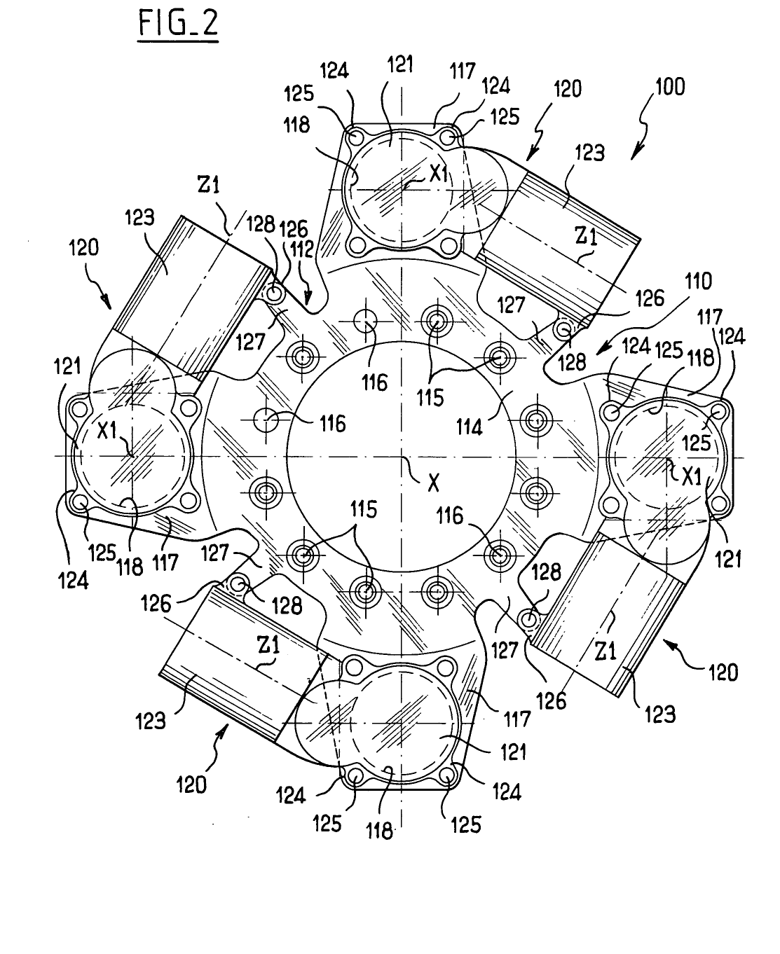

As can be seen in FIGS. 1 and 2, the ring portion 112 of the one-piece unit 110 has a plurality of lugs 117, there being four such lugs in this case, extending radially outwards, each lug supporting a corresponding electro-mechanical actuator 120. It should be observed that the lugs 117 of the ring portion 112 of the one-piece unit 110 extend in a plane perpendicular to the axis X, which plane is offset forwards in this example relative to the plane of the flange 114 for securing said unit. This offset enables the electro-mechanical actuators 120, and in particular their electric motors, to be better integrated.

Specifically, each electro-mechanical actuator 120 comprises a housing 121 receiving a screw-and-nut system (not shown in the figures) which is associated with driving the pusher 122 of said actuator, and an electric motor 123 associated with said housing, being secured to said housing so as to be cantilevered out therefrom (naturally, other actuator structures could be provided, with the motor surrounding the screw-and-nut system). Each housing 121 receiving a screw-and-nut system for driving the pusher has a central axis X1 which is parallel to the axis X of the axle 11. The electric motor 123 of each electro-mechanical actuator 120 extends, in the arrangement shown, in a circumferential direction Z1.

As can be seen more clearly in FIG. 2, the housing 121 presents four peripheral appendices 124 enabling it to be secured to the corresponding lug 117 by bolts 125. It should be observed that the housing 121 also passes through the corresponding lug 117 onto which it is secured directly, passing through an opening 118 in said lug, as can be seen more clearly in FIG. 1.

If so desired, the electric motor 123 that is mounted in a cantilevered-out position on the housing 121 could be further supported by additional specific bolting. An example of such specific bolting is shown, comprising an appendix 126 on the housing of the motor 123 and an appendix 127 on the ring portion 112, the ring-portion appendix being disposed between two adjacent lugs 117, thereby enabling a fastener bolt 128 to be installed. Such additional fastening at the end of the housing of the electric motor 123 provides an assembly that is quite rigid, without significant increase in weight.

If it is desired to perform a maintenance operation on only one or another of the actuators 120, it then suffices to undo the fastener bolts 125, 128 of the actuator in question in order to be able to withdraw it without it being necessary to disassemble the entire one-piece unit forming the ring and the torsion tube.

In FIG. 1, there is also shown a heat shield 119 disposed in association with the pushers 122 of the various electro-mechanical actuators 120. This shield serves to protect the drive systems associated with the pushers 122 of the actuators.

Finally, and preferably, the one-piece unit 110 forming the ring 112 and the torsion tube 111 can be made out of a single material, e.g. steel.

The invention is not limited to the number electro-mechanical actuators nor to their structure, and in a variant it would be possible to have some other number of actuators and/or a fastening arrangement that is different on the ring portion of the one-piece unit 110.

More generally, the invention is not limited to the embodiment as described above, but on the contrary covers any variant using equivalent means to reproduce the essential characteristics as specified above.

1. An aircraft brake assembly comprising a stack of disks surrounding a wheel axle coaxially, said stack being made up of alternating rotor disks constrained in rotation with the wheel, and stator disks constrained in rotation with a torsion tube, and being pressed between a rear retaining piece and the pushers of a plurality of electro-mechanical actuators arranged circumferentially on front support ring, wherein the torsion tube and the ring supporting the electro-mechanical actuators together constitute a one-piece unit which is fastened to the axle, and the rear retaining piece is fastened in separable manner on said one-piece unit at one end thereof.

2. An aircraft brake assembly according to claim 1, wherein the one-piece unit forming the ring and the torsion tube presents a single flange where the ring and the torsion tube join each other, said flange extending in a plane perpendicular to the axis of said assembly and being fastened to a projecting collar on the axle.

3. An aircraft brake assembly according to claim 1, wherein the rear retaining piece is fastened to the one-piece unit, and the one-piece unit is fastened to the axle by bolt means.

4. An aircraft brake assembly according to claim 1, wherein the ring portion of the one-piece unit has a plurality of lugs projecting radially, each lug supporting an electro-mechanical actuator.

5. An aircraft brake assembly according to claim 4, wherein the lugs of the ring portion of the one-piece unit extend in a plane that is offset forwards relative to the plane of the fastening flange of said assembly.

6. A brake assembly according to claim 5, wherein each electromechanical actuator comprises a housing receiving a screw-and-nut system associated with driving the pusher of said actuator, and an electric motor associated with said housing, said housing passing through the corresponding lug onto which it is fastened directly.

7. A brake assembly according to claim 6, wherein the electric motor of each electro-mechanical actuator extends in a circumferential direction, and said motor is also fastened to the ring portion via an associated appendix thereof disposed between two adjacent lugs.

8. A brake assembly according to claim 1, wherein the one-piece unit forming the ring and the torsion tube is made out of a single material.
